(19) United States
(12) Patent Application Publication
(10) Pub. No.: US 2003/0144944 A1
(43) Pub. Date: Jul. 31, 2003

(54) Financial instruments trading system and method

(76) Inventors: David Samuels Kalt, Chicago, IL (US); Ned Wesley Bennett, Anthony, NM (US)

Correspondence Address: Charles C. Valauskas, BANIAK PINE & GANNON, Suite 1200, 150 N. Wacker Drive, Chicago, IL, 60606, US

(21) Appl. No.: 10/062,590

(22) Filed: Jan. 31, 2002

(51) Int. Cl. G06F 17/60

(52) U.S. Cl. 705/37

(57) ABSTRACT

The present invention is directed to a system and method by which the recommendations of a third party advisor chosen by an investor and with whom an investor has entered into a separate relationship can be matched with conditional trading criteria chosen by the investor. In a process for structuring such a trading system, when a matching correspondence occurs between the criteria specified in trades recommended by an advisory service and conditions chosen by the individual investor, the combined set of matching criteria then becomes the basis to initiate a formal trading order for the financial securities so defined. The trading order so generated may additionally include specified criteria not pre-defined by the investor, such as for example timing instructions that can be designated without prescription from the investor.

### FIELD OF THE PRESENT INVENTION

The present invention relates to a system and method that facilitates the efficient management and trading of financial instruments. More particularly, the invention relates to a computerized online system and process that permits an investor to structure an automated online interaction between one or more independent financial advisory service providers, the individual investor, and an independent financial instrument ordering service so that orders are placed after trading recommendations offered by the one or more advisory service providers chosen by the investor agree with trading criteria pre-selected by the individual investor.

### BACKGROUND OF THE INVENTION

Investors may engage in the trading of a wide variety of properties to achieve some financial or other advantage. For example, investors may choose from a wide variety of financial instruments such as corporate stocks and stock options, mutual funds, fixed-income securities, commodity futures and options, index futures and options, among others. Investors may also engage in the trading of other items whose value varies according to market perception such as coins, stamps, books, objects of fine art, craftsmanship, and those having historical significance, among other collectible items. The present invention has potential application to all such financial instruments, items, and properties that may bought and sold in a generally open marketplace at a price that varies according to market perception, but may have heightened relevance with respect to the trading of stock equity options.

Stock options are essentially contract rights that can be bought and sold on the open market. By paying a certain premium amount, the owner of an option acquires the right to buy or sell the underlying security at a designated strike price during a limited period of time prior to expiration of the option. Buyers and sellers of options are termed “holders” and “writers,” respectively. A call option is an option to buy a certain stock at a specific price on or before a certain date. If the underlying corporate stock issue increases in value over the strike price, the value of the call option then increases, as well. The owner of a call option may exercise the right to purchase the stock before the expiration date of the option, logically whenever the stock exceeds the strike price, at which time the option seller becomes obligated to sell the stock. If the stock does not exceed the strike price, the owner has lost nothing more than the price paid for the option, or the option premium. A put option is an option to sell a stock at a specific price on or before a certain date. The owner of a put option may exercise the right to sell the stock before the expiration date of the option, logically whenever the stock falls beneath the strike price, at which time the option seller becomes obligated to buy the stock. If the stock does not fall beneath the strike price, the owner has again lost nothing more than the option premium.

To offset potential financial liabilities that might otherwise accrue from changes in the value of an underlying stock issue, investors often seek to acquire option rights as a type of financial insurance policy. Similar to paying an insurance premium, the cost of buying call options becomes a standard business expense, required for proper risk management. In like manner, investors sell put options to obtain a calculable minimum return on investments as a means for ensuring against financial risk. Separate and apart from their risk management function, stock equity options may furthermore provide investors with a potentially lucrative trading instrument, allowing for investment in the performance of the underlying security with a lesser amount of investment capital required.

Investing in traded stock options typically requires specialized financial knowledge. Without it, individual investors may not be aware of the benefits and opportunities that trading in certain options provide, nor the range of possible trading strategies. However, the average individual investor does not have access to the same quantity and quality of market information that is ordinarily available to those routinely involved in trading options. Even sophisticated investors may recognize the value of complementing the information they have with advice from knowledgeable sources concerning current economic variables and conditions, price levels forecasted for particular corporate stocks or other securities, and the appropriateness of certain specific trades. To illustrate, trading from which a profit may be realized on an ongoing basis necessitates that the investor make the best possible decision regarding the timing of the trade. Specifying both a proper price and a proper time for trading, and then acting in a timely fashion to obtain maximum advantage, tends to decrease the risk of trading and increases the opportunity to realize a profit from such trades.

Once again, it should be noted that investors may engage in the trading of a wide variety of properties to achieve some financial or other advantage. For example, investors may choose from a wide variety of financial instruments such as corporate stocks and stock options, mutual funds, fixed-income securities, commodity futures and options, index futures and options, among others. Investors may also engage in the trading of other items whose value varies according to market perception such as coins, stamps, books, objects of fine art, craftsmanship, and those having historical significance, among other collectible items. The present invention has potential application to all such financial instruments, items, and properties (collectively identified for purposes of this application as “financial instruments”) that may bought and sold in a generally open marketplace at a price that varies according to market perception, but may have heightened relevance with respect to the trading of stock equity options.

Individual investors typically obtain their financial advice from many different sources but may come to rely on those advisors that demonstrate an expertise in those investment areas of interest to the investor. To satisfy the public demand for reliable market advice and information, most financial service providers periodically publish a newsletter or brochure containing articles, either in printed form or as accessible online via e-mail or the internet. To have access to highly detailed forms of trading information, the investor must typically enter into a subscription agreement with the advisory service provider, and pay a subscription fee. Advisory information so offered may specify a stock issue and type of option, a duration period before expiration of the option, and a time interval appropriate for either buying or selling the option. The specified criteria of recommended trades may include also a strike price for trading the option, and an acceptable price range for the option premium. The specific trades recommended by an advisory service provider may be described by a greater or lesser multiple of such definable criteria.

To make proper use of the trading recommendations contained in an advisor's publication, an investor typically will consider all the information provided and determine whether the trades recommended may be appropriate for the investor's personal financial objectives. More selective investors will require that a greater number of conditional criteria be applied to their trading decisions. However, because most individual investors do not have the time and access to regularly monitor market activity, to receive and process price and volume information reported from the floor of the exchange, and to enter and fulfill trades based upon the advice of third-party sources, while at the same time conducting such trading activities in accordance with their own selected trading preferences and financial priorities, the investors typically do not realize the full value of opportunities presented to them.

A demand therefore exists for a system and process whereby various trading recommendations offered by one or more financial advisory service providers can be readily accessed and surveyed by individual investors, and whereby the particular elements of such recommended trades can be accurately and efficiently compared to the trading conditions that individual investors may require. The present invention satisfies the demand for this type of structured trading system.

### SUMMARY OF THE INVENTION

The present invention is directed to a system and method by which the recommendations of a third party advisor chosen by an investor and with whom an investor has entered into a separate relationship can be matched with conditional trading criteria chosen by the investor. In a process for structuring such a trading system, when a matching correspondence occurs between the criteria specified in trades recommended by an advisory service and conditions established by the individual investor, the combined set of matching criteria then becomes the basis to initiate a formal trading order for the financial securities so defined. The trading order so generated may additionally include specified criteria not defined by the investor, such as for example timing instructions that can be designated without prescription from the investor.

In a preferred embodiment, the invention permits the investor to establish certain trading criteria as conditions required to initiate trading orders on the investor's behalf. The minimal criteria for such conditions may identify the type of security or securities traded (such as stock or a stock option) and the amount of monetary funds the investor wishes to assign to designated trading accounts. Additional criteria for initiating trades may include defined elements such as the class or series of corporate stock for the option being traded. The investor may also further require non-specific trading instructions, such as the percentage of total investment assets allocated to any particular trade or range of potential trades.

From an array of multiple third-party advisory service providers, the investor will typically receive financial information from one or more of such advisory service providers. At the same time, the investor enters into a contractual agreement with a brokerage firm that has access to the same information provided by the advisory services. The brokerage firm agrees to initiate trades on the investor's behalf according to recommendations offered by such third party advisors, whenever the particular criteria defined by such trading recommendations meet and coalesce with similar particular conditions as pre-determined by the investor. The conditional criteria specified by the investor may also be modified, as the investor's trading preferences and financial priorities change over time.

By preference, the trading system so described may operate automatically so that the trading order is entered immediately whenever the investor's trade criteria match the third party advisor's recommendations. Alternatively, if the recommendations from the advisory service are not communicated in such a form as to permit automatic entry, particularized criteria to define the qualified trading recommendations can be communicated personally to an individual or individuals having responsibility to organize and interpret the trading recommendations so provided, and to convey the instances where a coalition between individuals and advisory service providers may occur, or where an investor's pre-defined trading criteria may have been reached in the trading recommendations offered. At that point, a system operator working within a brokerage firm generates a trading order and the order so generated is brought to the exchange, for fulfillment of the transaction similar to orders generated by the system automatically.

From the perspective of the individual investor, one advantage to the invention is that it permits investments to be made according to the recommendations of a party chosen by the investor, apart from any conflicting interests that might otherwise imply a certain bias inherent to the advice offered by brokerage firms, in their dealings with individual investors. Another advantage that accrues to the individual investor in the present invention derives from having a lag time, during the period before an actual trade is generated, to observe market activity in the sector area or specific options or issues pre-selected by the investor. Having the advantage of this lag time period provides the investor with an extra layer of protection, for example against negative consequences of particularly persuasive sales tactics, impulsive trading decisions, or other such eventualities. Riskier investment choices or decisions not otherwise appropriate for the investor's portfolio may thereby also be avoided. A further advantage of the present invention involves the expanded opportunity provided to investors for participation in certain securities markets that might not otherwise have been prudent or possible, considering the specialized information and trading expertise required, where complex trading decisions in the relevant markets must be formulated in real time, on a daily basis. Once the investor's trading account and conditional criteria are established, the system of the present invention allows financial investments to be made upon the initiative of an automated process. Yet another advantage accrues from the fact that trades are executed automatically upon a matching of trading criteria, without external intermediation. This aspect of the invention is also advantageous from the perspective of the advisory information service, since trading recommendations are promulgated without consideration of any particular individual investor's pre-stated conditional trading criteria. The responsibility for the profit or loss resulting from trades recommended by the advisory service provider thus remains with the individual investor. The invention is also advantageous to the brokerage or system operator, since the process of matching recommended trades with investor's trading criteria does not implicate a financial responsibility for the trade, but improves the accuracy and efficiency of processing trading orders for bookkeeping purposes, and adds innovative capabilities for providing brokerage services to individuals.

A principal object of the present invention is therefore to provide a system and method by which an investor may have securities trades executed based upon recommendations received from a selected third party source. Since the third party's recommendations remain impersonal and impartial, in the sense that they are not influenced by a prior knowledge of any given investor's trading conditions, and since the advisory service selected by the investor acquires no financial obligation either to the investor or the system operator, another principal object of the present invention is to provide a system and method by which investments can be made automatically, without implying any underlying bias whereby, for example, the brokerage firm or investment system operator might improperly seek to increase trading volume.

An additional object of the invention is to provide an online trading system and methods for structuring a system for online trading of financial securities, to include configurable computer software that permits the investment system operator to monitor on a continuous basis communications from third party recommendation sources and from investors, and to increase the efficiency of such monitoring functions by means of programmed control using automated data processing, thus to provide means whereby trading orders from individual investors may be initiated and subsequently fulfilled without requiring further intervention from the operator.

These, together with other objects and advantages, will be further understood in the details of the construction and operation of the invention as more fully hereinafter described, and with reference to the accompanying drawings, forming a part hereof, wherein the numerals refer to the like part throughout.

### BRIEF DESCRIPTION OF THE DRAWINGS

FIG. 1 is a block diagram of an embodiment of the present invention, that illustrates the operation of the investment system;

FIG. 2a is a schematic flowchart depicting the process by which an investor may initialize a securities trading account in accordance with the present invention, coordinating account initialization with a financial service provider and a system operator;

FIG. 2b shows a flowchart for market monitoring by the automated and semi-automated process of the present invention; and

FIG. 2c illustrates continuation of the market monitoring process, with initiation of trade orders.

### DETAILED DESCRIPTION OF THE PRESENTLY-PREFERRED EMBODIMENTS

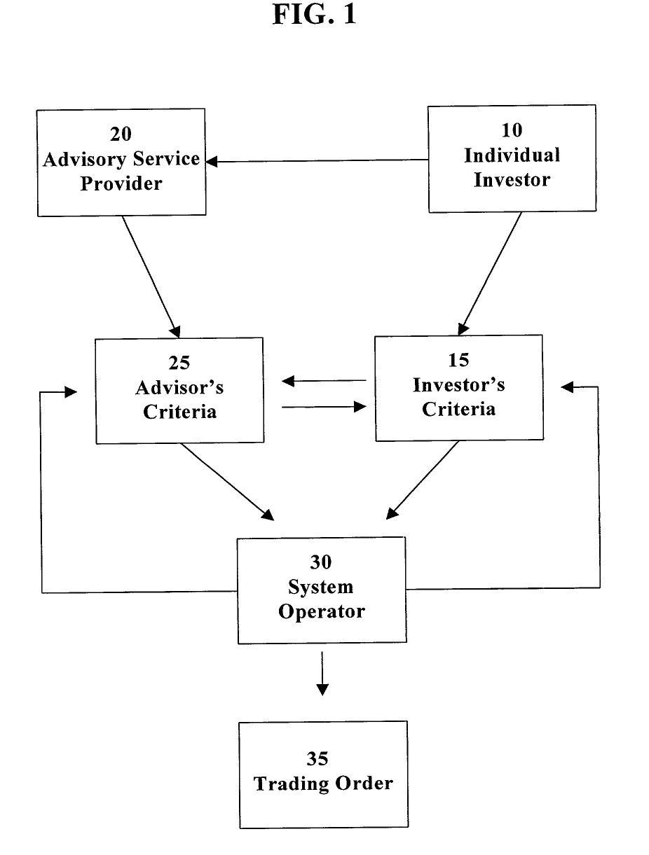

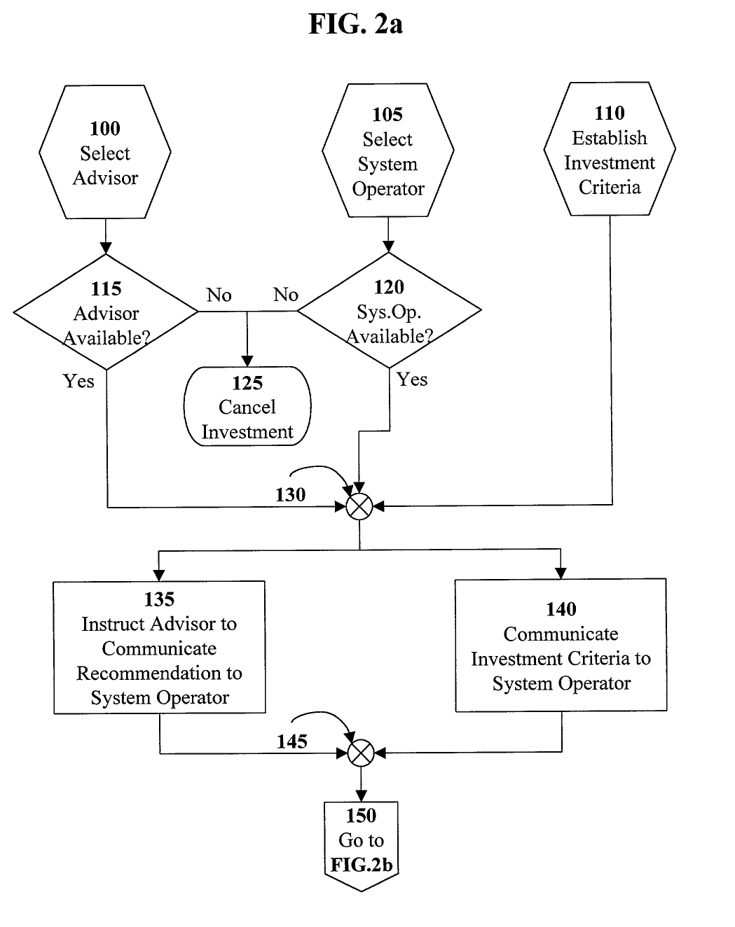

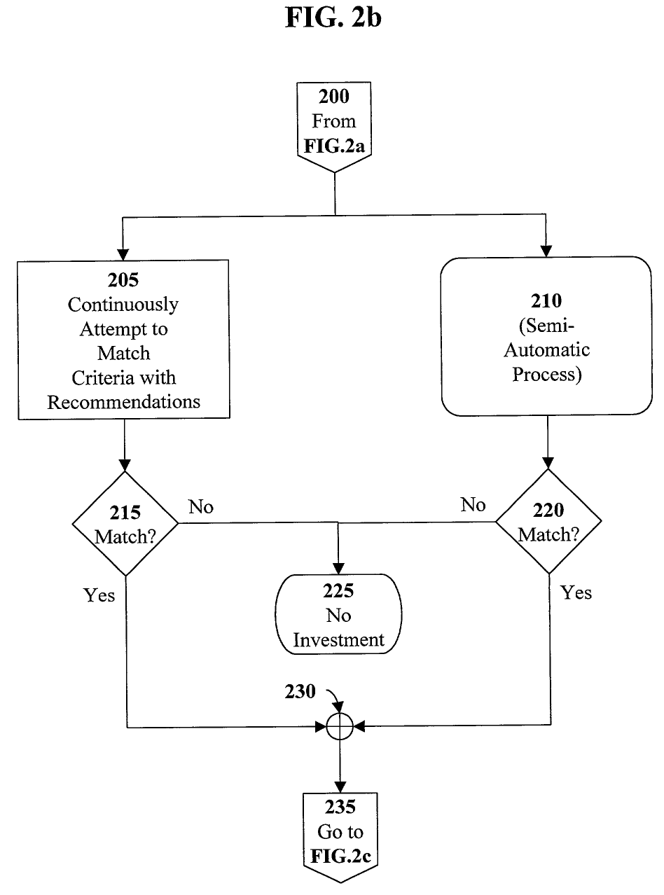

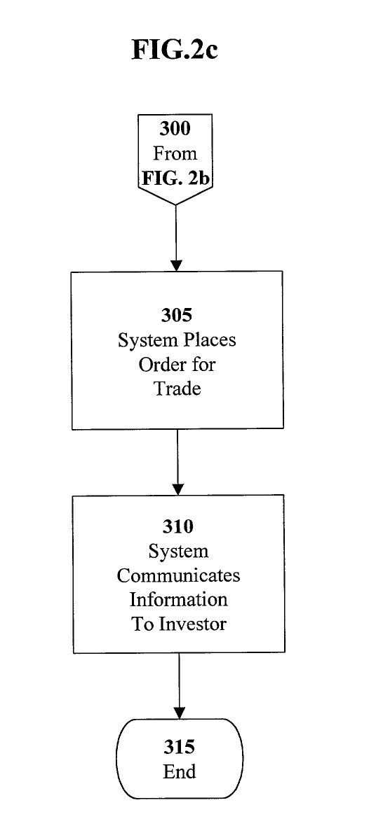

FIGS. 1 and 2 illustrate a system and method by which an independent and individual investor may trade in financial instruments, and where informed trading decisions (effectuated by an independent system operator) are based upon confirmed recommendations provided by one or more third party, or independent, financial advisory services.

Preferably, referring to FIG. 1, which illustrates financial instruments trading system 5 of the present invention, interactions between individual investor 10, independent financial advisory service provider 20 and independent system operator 30 are conducted primarily by means of a computerized form of informational communication. For example, the system 5 may conduct business online, such as via the World Wide Web (WWW), the Internet or any other form of online informational communication means, whether that means be digital, analog or a combination. Alternatively, the system 5 may also be conducted via any other means of informational communication, such as, for example, via a telephone, via a two- (or multi-) way radio or through the mail.

For purposes of the present invention, a financial advisory service provider is any individual or entity which provides financial instrument information in the preferred form of advice, recommendation, or the like, as to whether to buy, sell, hold, or perform another financial transaction, on a specific financial instrument. Moreover, the financial advisory service provider does not gain a benefit from the acting on of the advice (e.g., when the order is placed), but rather benefits upon the mere dissemination of the information.

For purposes of the present invention, the independent system operator is an individual or entity that acts as a liaison between both the independent investor and the financial advisory services provider. It receives information from both the independent investor and the financial advisory services provider, and performs the desired tasks requested by the individual investor if (and only if) there is a match between the two forms of information received. In cases in which there is not a match, no transaction is effectuated. The system operator may comprise a completely automated system, a semi-automated system or a non-automated system.

Thus, as illustrated in FIG. 1, individual investor 10 subscribes to receive financial instrument information from financial advisory service provider 20. Preferably, individual investor 10 chooses financial advisory service provider 20; however, individual investor 10 may select financial advisory service provider from a prior list of “approved” or appropriate providers, or may even have a provider pre-selected. According to a mode of typical practice, any financial advisory information provided to individual investor would most likely be provided in the form of a publication—written, oral, electronic or other—including one or more trading recommendations.

For purposes of illustration, in FIG. 1, one individual investor 10, one financial advisory service provider 20 and one independent system operator 30 and is illustrated. However, in practical application of financial instruments trading system 5, the same basic arrangement may include additional entities. As a result, multiple investors may access financial instruments information offered by several advisory service providers simultaneously.

As shown in FIG. 1, financial transactions recommended by financial service provider 20 are defined in terms of their specifiable elements, or advisor's criteria 25. This advisor's criteria 25 characterize the recommended financial transaction, from the point of view of financial service provider 20, with sufficient particularity so as to permit initiation of a financial transaction. For example, in the case of stock equity options, such advisor's criteria 25 may include the underlying stock issue, the type of recommended stock equity option (i.e., call or put), the strike price for the underlying stock issue, the time duration before expiration of the stock equity option and the current, or most, recent bid or asked market price of the stock equity option. Additional specific criteria could be added if more elaborate or detailed trading recommendations are desired.

Advisor's criteria 25 are then communicated to independent system operator 30. This communication may be effectuated either in computerized form (for example, as a record file formatted for an existing database) or, as one alternative, in a verbal form (for example, via a telephone).

As further shown in FIG. 1, independent investor 10 also sets forth a list of specific conditional trading criteria 15. At the same time when such trading criteria 15 are specified, independent investor 10 transfers funding amounts sufficient to execute financial transactions to an account managed by independent system operator 30, or, in typical practice, for example, by the accounting services of a brokerage firm. Margin requirements for such transactional trading accounts may be established in accordance with exchange regulations by agreement between individual investor 10 and independent system operator 30. In such a case, independent system operator 30 then becomes responsible for monitoring the activity of any relevant exchange markets, as well as any trading recommendations issued by financial advisory service provider 20. When trading criteria 15 established by independent investor 10 matches the corresponding advisor's criteria 25 for financial transactions recommended by financial advisory service provider 20, brokerage order 35 for the financial transaction is preferably automatically entered at the first possible instance.

FIG. 2 provides a more specific discussion of the operation of the present invention. For clarity, FIG. 2 is divided into three separate modules representing the various stages of financial instruments trading system 5. As illustrated in FIG. 2a, the process for initializing a trading account for independent investor 10 requires selection by individual investor 10 of financial advisory service provider 20. This is illustrated in Block 100. Upon receiving the selected financial advisory service provider 20 from independent investor 10, financial instruments trading system 5 of the present invention performs a determination as to whether financial advisory service provider 20 is “within the system.” That is, financial advisory service provider 20 presumably would need to be registered to interact with financial instruments trading system 5. This is illustrated in Block 115. Such registration may be formal (i.e., registration process prior to being selected) or informal (i.e., conducting a registration process after or during selection by independent investor 10). If financial advisory service provider 20 is not available or cannot be registered with financial instruments trading system 5, then, as is illustrated by Block 125, the investment is cancelled.

Additionally, independent investor 10 selects independent system operator 30. This is illustrated in Block 105. Similar to the description immediately above, upon receiving the selected independent system operator 30 from independent investor 10, financial instruments trading system 5 of the present invention performs a determination as to whether independent system operator 30 is “within the system.” That is, independent system operator 30 presumably would need to be registered to interact with financial instruments trading system 5. This is illustrated in Block 120. Such registration may be formal (i.e., registration process prior to being selected) or informal (i.e., conducting a registration process after or during selection by independent investor 10). If independent system operator 30 is not available or cannot be registered with financial instruments trading system 5, then, as is illustrated by Block 125, the investment is cancelled.

At the same time, independent investor 10 sets forth conditions to establish one or more specifiable conditional trading criteria 15. This is illustrated in Block 110. At this point, the trading account is initialized, and all information selected or established by independent investor 10 is collected and transferred, within financial instruments trading system 5 to independent system operator 30. Summation Step 130 illustrates this.

When the trading account is initialized, financial instruments trading system 5 then requests financial advisory service provider 20 to communicate recommendations (i.e., those recommendations proffered by financial advisory service provider 20) to financial instruments trading system 5. Thereafter, financial instruments trading system 5 may preferably record and store the trading recommendations. Block 135 illustrates this step. In parallel, financial instruments trading system 5 additionally monitors communications from independent investor 10. Preferably financial instruments trading system 5 records and stores a summary of trading criteria 15 (i.e., that criteria specified by individual investor 10), including trading criteria 15 which has been revised or modified subsequent to account initialization. Block 140 illustrates this step.

The incoming sets of data from the two parallel sources having been received, as illustrated by Summation Step 150, the present invention proceeds to FIG. 2b. FIG. 2b describes the second component process module of financial instruments trading system 5, where combined datasets containing parallel specifiable criteria, output from the first module (as described in FIG. 2a), are transferred to a separate computerized process 200, and where the two parallel parts of criteria 15, 25 are compared against each other. Both Blocks 205 and 210 illustrate this.

For instances where a positive match corresponding between parallel criteria occur, financial instruments trading system 5 initializes a third component module; that of performing the transaction desired by independent investor 10. This is illustrated in Block 205 of FIG. 2b. As is shown by Block 205, financial instruments trading system 5 performs this on a totally automated basis. As an alternative, Block 210 illustrates that the performance of the desired transaction may be semi-automatic; that is, portions of the transaction may be performed in a manner other than electronic.

In Blocks 215 and 220, financial instruments trading system 5 determines whether a match has been made. Where no such positive match occurs, there is no investment (refer to Block 225).

In the third component module of financial instruments trading system 5, as shown in FIG. 2c, a positive correspondence resulting from the process of matching parallel criteria will generate a trading order that is entered automatically by financial instruments trading system 5. This is illustrated in Block 305. In a subsequent step, the system may also communicate information about the recently-placed trading order to independent investor 10, as illustrated by Block 310.

It should be appreciated that the embodiments described above are to be considered in all respects only illustrative and not restrictive. The scope of the invention is indicated by the following claims rather than by the foregoing description. All changes that come within the meaning and range of equivalents are to be embraced within their scope.

What is claimed is:

1. A system for conducting managed trading in financial securities, said system including: means for receiving and storing information from advisory service providers; means for distributing said information to individuals; said information including criteria describing the financial securities to be traded; means for receiving and storing selection information from said individuals where said selection information includes criteria describing conditional trading orders; processing means for comparing the criteria describing the financial securities to be traded against the criteria describing the conditional trading orders to determine instances of partial or identical correspondence; and means for execution of a trading order for a purchase or sale of financial securities where such trading order includes one or more of the aforementioned criteria.

2. The managed trading system of claim 1, wherein the financial securities are stocks, bonds, stock options, bond options, commodities futures, commodities future options, index futures, index futures options, mutual funds, currencies, or metals.

3. A system for conducting managed trading in collectible items, said system including: means for receiving and storing information from advisory service providers; means for distributing said information; said information including criteria describing the items; means for receiving and storing selection information from individuals where the selection information includes criteria describing conditional trading orders; processing means for comparing the criteria describing the items to be traded against the criteria describing the conditional trading orders to determine instances of partial or identical correspondence; and means for execution of a trading order for a purchase or sale of items where such trading order includes one or more of the aforementioned criteria.

4. An improved method to facilitate managed trading of collectible items, where an individual designates conditional criteria for trading such items, where a service provider designates certain recommended trading criteria, and where a system operator monitors trading activity between buyers and sellers, the method comprising the steps of:
a) recording and storing sets of conditional trading criteria designated by individuals;
b) recording and storing sets of recommended trading criteria designated by service providers;
c) comparing the criteria contained in said sets of recommended and conditional trading criteria;
d) identifying instances of partial or identical correspondence between sets of criteria so compared; and
e) generating a trading order, where such trading order includes one or more of the aforementioned criteria.

5. The managed trading system of claim 4, wherein the traded items are: coins, stamps, books, objects of fine art and craftsmanship, collectible items having historical significance, or other items of collectible value.

6. The managed trading method of claim 5, wherein the traded items are: coins, stamps, books, objects of fine art and craftsmanship, collectible items having historical significance, or other items of collectible value.
